(19) United States
(12) Patent Application Publication
(10) Pub. No.: US 2007/0239922 A1
(43) Pub. Date: Oct. 11, 2007

(54) Technique for link reconfiguration

(76) Inventor: John W. Horigan, Mountain View, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/299,103

(22) Filed: Dec. 9, 2005

(51) Int. Cl. G06F 13/40; G06F 13/38

(52) U.S. Cl. 710/307; 710/66

(57) ABSTRACT

A technique to reconfigure a link within a common system interface (CSI) link. More particularly, embodiments described herein relate to transmitting a signal to reconfigure a link while data is concurrently allowed to be transmitted across the link.

### FIELD

Embodiments of the invention relate to electronic networks. More particularly, embodiments of the invention relate to virtualizing interconnective paths between two or more electronic devices residing in an electronic network.

### BACKGROUND

In typical electronic networks, particularly those composed of a number of interconnected bus agents (e.g., semiconductor devices) within a computer system, some of the physical interconnective pathways may be driven to a constant value for the duration or some other period of operation of the network. Within an electronic network, such as a computer system, this means that certain bus traces that connect bus agents within the computer system may be driven to a static value, such as a logical “1”, “0”, or an indeterminate value, such as “tri-state”.

Driving a particular bus trace to a value typically requires the input/output (“I/O”) of one of the bus agents connected to the bus trace to force the value onto the bus trace, thereby using power for the duration of the operation of the computer system. Similarly, an I/O of the receiving agent may also consume power while the transmitting agent is driving a constant value. The term “drive” when used in the context of a value placed on a bus, can also refer to the static power drawn when no current is flowing in the bus or corresponding I/O. Alternatively, the bus trace may be connected to a circuit that holds the device at a certain state without requiring a device I/O to drive the bus trace to that value. However, in this configuration the circuit that drives the bus trace to a particular value may consume current and therefore contribute to the power consumption of the computer system.

FIG. 1 is a prior art example of a portion of a computer system in which a bus trace connecting two bus agents drives a constant value onto the bus trace in order to represent a static value. In some prior art applications, the driver may consist of an inverter circuit, for example, that draws power due to leakage currents within the semiconductor devices of which the circuit is composed.

In a typical point-to-point (PtP) computer system in which a common system interface (CSI) bus architecture and protocol is used, each link between the bus agents may contain numerous traces or “lanes” that are used to transmit data from a transmitting agent to a receiving agent. Regardless of whether the lanes are operating in a dynamic, or “switching” mode, or a static mode, in which a constant value is driven onto the lane, power may be drawn by the lane due to, for example, leakage or other sources within the input/output (“I/O”) circuits within the receiving and/or transmitting agents.

Occasionally, the lanes may be reconfigured to a different width to support a different width of data, or different lanes having the same width may be configured to transmit data while other lanes are deactivated. Some prior art networks may deactivate all lanes between two or more interconnect agents while the lanes are reconfigured, or “retrained”. Deactivating all lanes can cause performance degradation as data must wait until the reconfiguration is complete before being transmitted along the network. Accordingly, performance bottlenecks may result.

### BRIEF DESCRIPTION OF THE DRAWINGS

Embodiments of the invention are illustrated by way of example and not limitation in the figures of the accompanying drawings, in which like references indicate similar elements and in which:

FIG. 1 is a prior art portion of a computer system in which a driver is used to drive a bus trace connecting two bus agents to a particular static value.

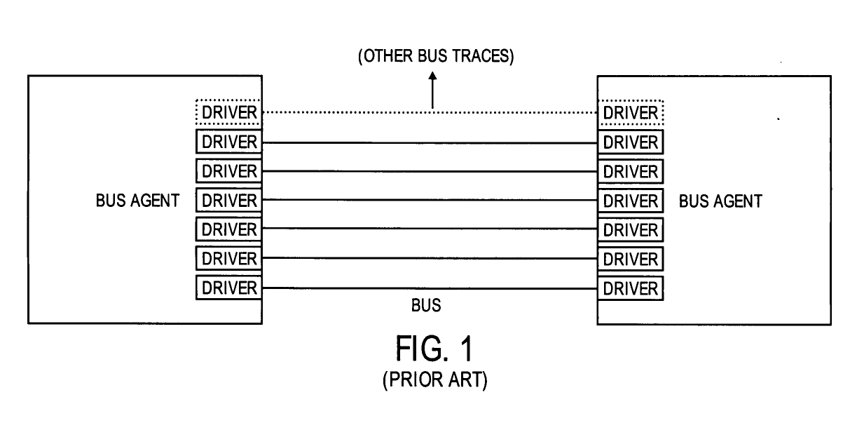

FIG. 2 is a PtP computer system in which at least one embodiment of the invention may be used to virtualize static lanes within a link between two or more bus agents.

FIG. 3 illustrates two bus agents of a common system interface (CSI) link in which at least one embodiment of the invention may be used.

FIG. 4 is a state diagram illustrating various aspects of an initialization process according to one embodiment of the invention to enable the virtualization of at least one lane of a PtP link within a computer system.

FIG. 5 illustrates a circuit in which a logic value may be represented within a bus agent, according to one embodiment of the invention.

FIG. 6 illustrates the flit format and phit order for a full-width link, according to one embodiment of the invention, wherein one 80 bit flit is organized in four 20 bit phits.

FIG. 7 illustrates a flit format and phit order for a half-width link, according to one embodiment of the invention, wherein one 80 bit flit is organized in eight 10 bit phits.

FIG. 8 illustrates a flit format and phit order for a quarter-width link, according to one embodiment of the invention, wherein one 80 bit flit is organized in sixteen 5 bit phits.

FIG. 9 illustrates a flit format and phit order for a full, half, and quarter-width link according to an alternative phit grouping in one embodiment of the invention.

FIG. 10 illustrates a link being reconfigured according to one embodiment of the invention.

FIG. 11 is a flow diagram illustrating operations that may be used to reconfigure a link according to one embodiment of the invention.

### DETAILED DESCRIPTION

Embodiments of the invention relate to electronic networks. More particularly, embodiments of the invention relate to the virtualization of interconnective paths between two or more electronic devices residing in an electronic network.

Some embodiments of the invention described herein relate to a bus trace (“lane”) virtualization technique for point-to-point (PtP) computer systems implementing a common system interface (CSI) to communicate data between the various agents within a PtP network. However, the principles described herein may readily be applied to other computer systems in which other bus topologies, architectures, and/or protocols are implemented. Advantageously, embodiments of the invention described herein can reduce the power drawn by static lanes within the computer network as well as reduce the number of lanes and/or device pins required to interface various bus agents within the computer system. Furthermore, embodiments of the invention enable buses of different widths to dynamically configure themselves to communicate over a CSI link.

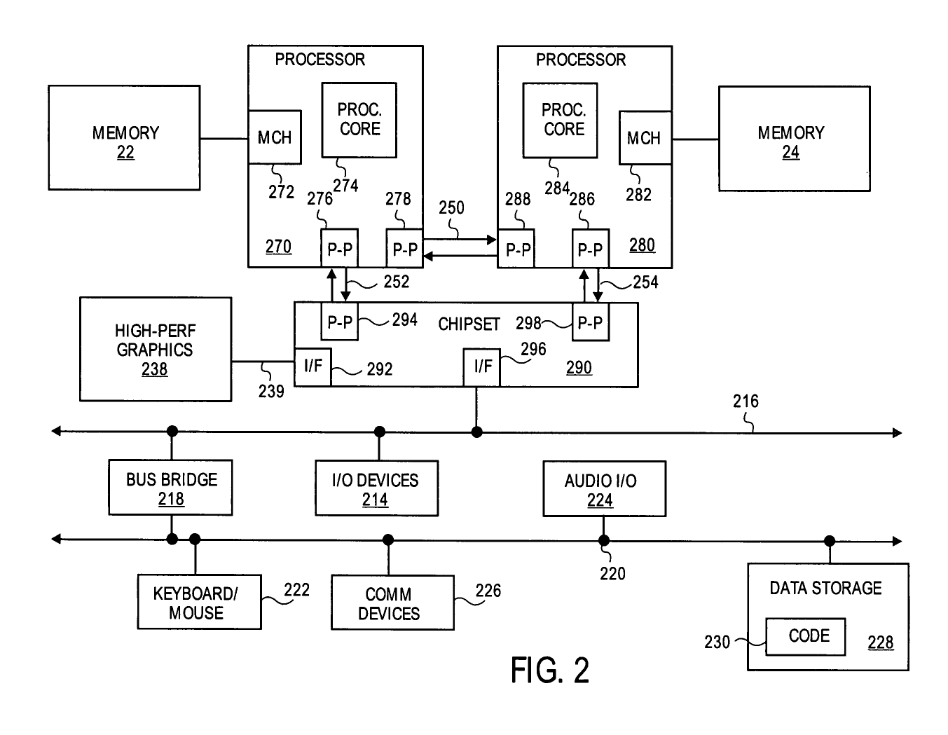

FIG. 2 illustrates a computer system that is arranged in a point-to-point (PtP) configuration. In particular, FIG. 2 shows a system where processors, memory, and input/output devices are interconnected by a number of point-to-point interfaces.

The system of FIG. 2 may also include several processors, of which only two, processors 270, 280 are shown for clarity. Processors 270, 280 may each include a local memory controller hub (MCH) 272, 282 to connect with memory 22, 24. Processors 270, 280 may exchange data via a point-to-point (PtP) interface 250 using PtP interface circuits 278, 288. Processors 270, 280 may each exchange data with a chipset 290 via individual PtP interfaces 252, 254 using point to point interface circuits 276, 294, 286, 298. Chipset 290 may also exchange data with a high-performance graphics circuit 238 via a high-performance graphics interface 239.

At least one embodiment of the invention may be located within the PtP interface circuits within each of the PtP bus agents of FIG. 2. Other embodiments of the, invention, however, may exist in other circuits, logic units, or devices within the system of FIG. 2. Furthermore, other embodiments of the invention may be distributed throughout several circuits, logic units, or devices illustrated in FIG. 2.

In at least one embodiment of the invention, a link consists of 20 of uni-directional lanes, some of which may be configured to a static value. In other embodiments, however, a link may consist of 20of bidirectional lanes, some of which may be configured to a static value. Although static lanes may not consume dynamic power from switching between logical values, static lanes may in fact consume power by being driven to a static logical value by bus agent I/O's or by logic circuits within the lanes that hold various lanes to a logical value. Embodiments of the invention may reduce power consumption below that of a system in which a static logical value is driven onto the bus, as embodiments of the invention may allow the I/O's themselves to be disabled and/or the corresponding bus trace (or “lane”) to be removed altogether.

In some embodiments, computer systems may have one or more lanes, such as those corresponding to sideband signals, such as platform-specific configuration signals, or cyclic redundancy check (CRC) error checking signals, within a link to be assigned a static value. Other signals, not just CRC and sideband signals, may be assigned static values. In order for a receiving agent to detect the static value driven by a transmitting agent, embodiments of the invention communicate to a receiving agent that lanes of the CSI link are static without using a physical, power consuming, connection between a transmitting agent and the receiving agent.

In at least one embodiment of the invention, static lane power may be substantially reduced or eliminated altogether while also reducing pin count within a link by enabling the receiving agent to represent static lanes with a constant logical value rather than relying on the transmitting agent to drive the value on a lane or lanes of the link to the receiving agent. In order to help enable a receiving agent to generate static lane values, in one embodiment of the invention, a link initialization process, is performed in which a transmitting agent communicates information on physical lanes between the transmitting and receiving agents that indicate to the receiving agent, either explicitly or implicitly, that certain lanes should be assigned a static value.

Once the virtual lane initialization information is transmitted to the receiving agent, the receiving and transmitting agents may disable I/O circuits corresponding to the static lanes, thereby preventing the I/O's from drawing power for the duration of operation of the computer system. After receiving the virtual lane initialization information from the transmitting agent, the receiving agent may store the static logical bits within a circuit corresponding to the static lane(s), such that other CSI layers may interpret those lanes as having the assigned static values when exchanging packets of information with the physical CSI layer.

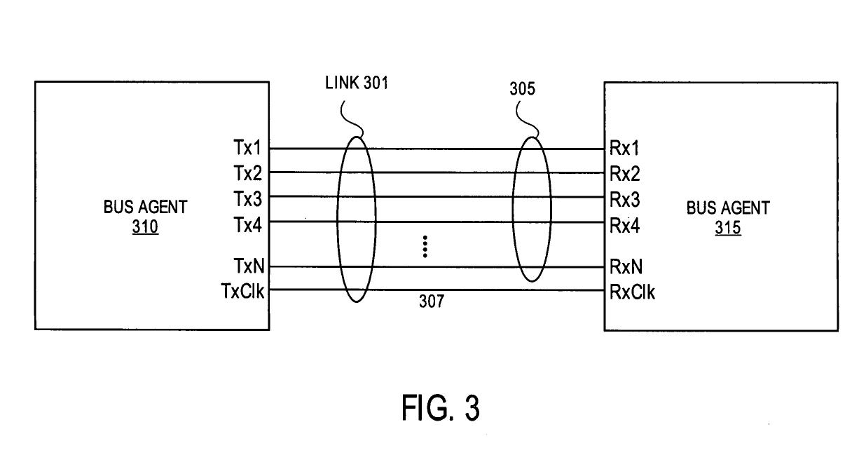

FIG. 3 illustrates two bus agents, 310 and 315, connected by a PtP link in which embodiments of the invention may be used. In the example illustrated in FIG. 3, the link 301 is composed of “N” number of lanes 305 and a clock signal 307. In at least one embodiment, N is equal to 20, but in other embodiments, N may represent one or more lanes. Furthermore, in some embodiments, the clock signal may not be present. The agents illustrated in FIG. 3 may be processors or other agents, such as an I/O controller hub, or some combination thereof.

The agents of FIG. 3 may be configured to assign static values to one or more of the lanes. Furthermore, in some embodiments, the static values may be assigned to a lane having a physical interconnect or a lane that does not have a physical interconnect. As long as at least one lane is physically interconnecting the agents with, and able to relay, a signal between the agents, embodiments of the invention may use the lane to configure the agents to virtualize any number of lanes in a link.

This may be useful when, for example, one of the agents uses a different number of lanes than the other or when there are fewer number of lanes actually being used than what are physically present in the link. In the event that the agents use a different number of lanes, embodiments of the invention may be used to detect this difference and configure the agents accordingly in order to virtualize unused lanes if necessary. For example, if agent 310 is an 18 pin transmitting agent (Tx) and agent 315 is a 20 pin receiving agent (Rx) (or vice versa) for purposes of a particular transaction or group of transactions, the two unused receiving lanes may, in addition to some of the used lanes, be assigned a static value, thereby creating at least two virtual lanes between the agents. In order to virtualize these two or more lanes, however, information about the lanes must be exchanged between the agents on at least one of the remaining used lanes. In at least one embodiment, the two agents detect and configure each other to virtualize any of the unused lanes, in addition to other lanes, by performing an initialization process.

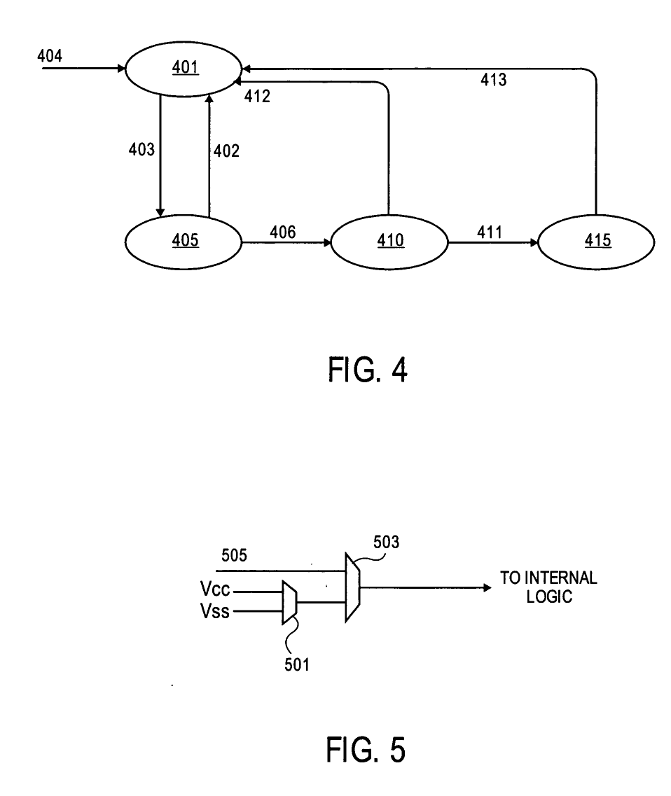

FIG. 4 illustrates a state diagram in which a virtual lane initialization technique may be realized according to one embodiment of the invention. In at least one embodiment of the invention, the virtual lane initialization technique illustrated in FIG. 4 is implemented within logic of a state machine of a bus agent within a PtP network of electronic elements. However, in other embodiments the initialization technique of FIG. 4 may be implemented in other ways, including software, processing logic, or some combination thereof.

Referring to FIG. 4, the disable/start state 401, is entered when the link between two electronic elements is powered on or in response to a reset event 404. In at least one embodiment of the invention, various register fields pertaining to the link interface may be reset, I/O ports of the link may be brought to a known impedance state, a link clock may be stabilized, and various calibration operations may be performed. A description of the precise operations performed during the disable/start state of the state diagram of FIG. 4, however, is not necessary to understand embodiments of the invention.

The detect state 405 is entered after the disable/start state has indicated it has finished its operations. In one embodiment of the invention, the disable/start state indicates the completion of operations by asserting a signal 403 to indicate to the detect state that it is acceptable to begin configuring the lanes to be virtualized.

In the detect state, two or more electronic elements of a link may detect each other's presence on the link. In one embodiment of the invention, two electronic devices compose a link and the two electronic devices may perform operations to determine various qualities of the other. For example, in at least one embodiment of the invention, each of the devices may be a transmitting agent and a receiving agent and therefore may drive or receive a signal, such as the clock signal of FIG. 4. Accordingly, the devices may attempt to detect a stable clock between each other. If an error in detection occurs, the detect state may return, indicated by transition 402, to the disable/start state.

After agents detect each other on a link, the state machine may transition 406 to the polling state 410. The polling state may involve several operations, including the removal of skew between the clock and data that is transmitted across the link. In addition, the polling state may include the removal of skew between data lanes themselves. Skew can exist between the clock and data lanes or between data lanes due to the physical characteristics of the link. In at least one embodiment, the removal of skew is performed in the receiving device. However, in other embodiments, skew may be removed in the transmitting device, or in both the transmitting device and the receiving device.

Also in the polling state, the number and identity of lanes to be virtualized can be determined, as the value to be assigned to the virtualized lanes. In one embodiment of the invention a sequence of serial bits, known as a “training sequence” (TS) may be used to encode and convey information pertaining to the virtualized lanes and their respective values. For example, in one embodiment of the invention, the identification of lanes to be assigned a static value, and therefore virtualized, are encoded in a sixth field within the TS, whereas the values of these static lanes are encoded within the seventh field of the TS. In other embodiments, the virtualized lane identification and value indicators may be encoded in other fields of the TS.

Furthermore, the width of the TS fields mentioned above may vary among embodiments of the invention as well as the number of bits that are actually used in the fields. For example, in one embodiment of the invention, only two CRC and two sideband lanes may be enabled to be virtualized lanes, in which case the respective TS words would contain at least two bits to identify the virtualized lanes and up to four bits to indicate the value of each virtualized lane. However, in other embodiments, more or fewer bits may be used in the TS to identify the static lanes and their values, depending upon the encoding used and the number of static lanes available. If there is ever a polling error detected, the state machine may return to the disable/start state indicated by transition 412 in order to re-start the initialization process.

In the polling state, lanes, including those not having a corresponding physical interconnect and/or a corresponding physical signal driven from one of the agents, can be virtualized by being assigned a static value. In order to configure a particular lane or lanes to be assigned a static value, for example, without the signal being actually transmitted, received, or even driven on the lane or lanes, the TS is used to configure the agents to assign a value corresponding to the virtualized lane. For example, in one embodiment of the invention, the TS is transmitted from one agent to another across all available and utilized lanes, even though one or more of the lanes may be assigned a static value and virtualized after the initialization process is complete.

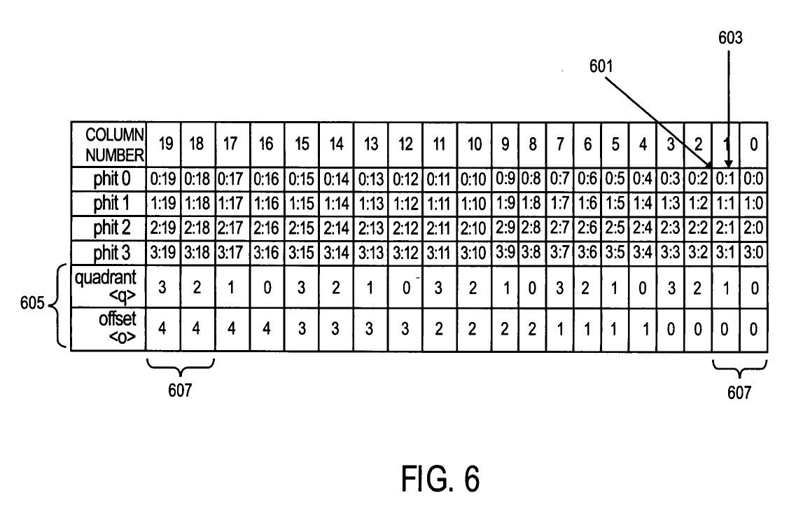

In one embodiment of the invention, the TS enables a circuit, such as the one illustrated in FIG. 5, in a receiving agent to output a static value, such as a logic ‘1’ or ‘0’ from Vcc or Vss, respectively, instead of a signal received from the I/O to which the virtual lane corresponds. Furthermore, in other embodiments, logic ‘1’ or ‘0’ could come from other sources besides Vcc or Vss. Particularly, the TS may contain bits, in some embodiments, to enable MUX 501 to pass either logic ‘1’ or ‘0’ from MUX 503 in the receiving agent instead of the I/O 505 signal.

In other embodiments, the circuit of FIG. 5, or one that performs a substantially similar function, may be configured not by a TS, but by data exchanged on the non-virtualized lanes either during the course of initialization or during normal operation of the link. In such an embodiment, values assigned to the virtual lane(s) may not be considered “static” per se, but may change dynamically by deriving the virtualized lane value(s) from the other non-virtualized I/O's. Furthermore, in some embodiments, the circuit of FIG. 5 may be accompanied or otherwise associated with more extensive logic internal to the receiving agent to decode data transmitted on other I/O's in order to enable virtualized lanes to be dynamically configurable to different values.

For example, in the case previously discussed of the Tx agent having 18 pins and the Rx agent having 20 pins, both of the lanes to which the extra 2 pins of the Rx agent correspond can be configured to a static value using bits within the TS. Alternatively, both of the extra two lanes to which the extra 2 pins of the Rx agent correspond can be configured to values that change or remain constant based on the value of one or some combination of the other signals transmitted over the other 18 lanes.

Although potential virtualized lanes may initially be marked as “bad” in the polling stage, they may ultimately be assigned a static value (via the TS data) or other static or non-static values from data exchanged between the agents on the other “good” lanes. If at least one good data lane is detected between the agents, the state machine enters 411 the configuration state 415.

The configuration state enables the link to be dynamically configured into varying widths, including quarter-width, half-width, and full width links. In order to support varying link widths, the physical layer of the link is organized as 20 lanes per link, in one embodiment of the invention, which can be configured into 10 lanes (half-width) or 5 lanes (quarter width). In full width (20 lanes), 80 link layer (“flit”) bits are organized as four groups of 20 bits (“phit”), which are transmitted across the 20 lane physical link sequentially. In half-width, a flit is transmitted across the physical link as 8 phits sequentially. Similarly, quarter width, a flit is transmitted across the physical link as 16 phits sequentially. If an error occurs in the configure state, the state machine may return to the disable/start state, indicated by transition 413, and the initialization process will restart.

Embodiments of the invention that implement the state machine illustrated in FIG. 4, allow devices having varying bus widths to detect each other's respective widths, negotiate a common width, and configure themselves to communicate accordingly over a CSI link. Although full, half, and quarter width bus configurations are explicitly described herein, other widths in other embodiments of the invention may be used, depending on the needs of the system or application. Furthermore, the widths may not be multiples of five, but may be other multiples of integer number of lanes or even one lane.

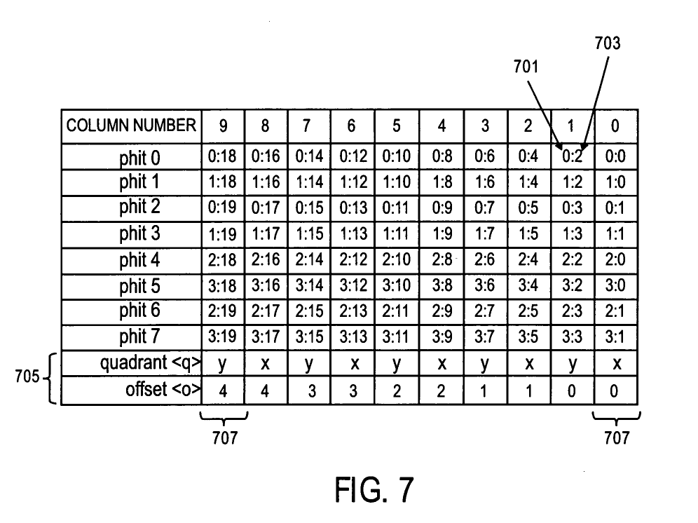

FIG. 6 illustrates the flit format and phit order for a full-width link, according to one embodiment of the invention, wherein one 80 bit flit is organized in four 20 bit phits. Each bit can be referenced by a quadrant number 601 and an offset number 603, in one embodiment of the invention. The quadrant number represents a quarter section of a link, whereas the offset number represents the bit position within the quadrant.

In one embodiment, the phits are transmitted across the link according to the quadrant/offset map 605 in FIG. 6. For example, for each phit transmitted across the 20 lane physical link, bits 0 through 3 of a phit are assigned to bit position 0 of quadrants 0 through 3, respectively. Similarly, bits 4-7 of each phit is mapped to bit 1 of quadrants 0 through 3, and so forth.

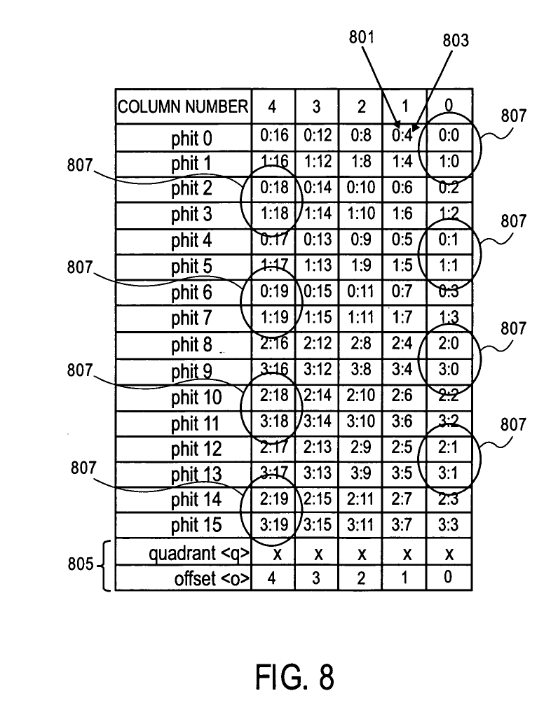

FIG. 7 illustrates the flit format and phit order for a half-width link, according to one embodiment of the invention, wherein one 80 bit flit is organized in eight 10 bit phits. Each bit is assigned a quadrant number 701 and an offset number 703, in one embodiment of the invention. The quadrant number represents a quarter section of a link, whereas the offset number represents the bit position within the quadrant.

In one embodiment, the phits are transmitted across the link according to the quadrant/offset map 705 in FIG. 7. However, unlike the full-width link, the half-width link has 10 lanes. Therefore, only two quadrants (x and y) are used to transmit each phit. For example, for each phit transmitted across the 10 lane physical link, bits 0-1 of a phit are assigned to bit position 0 of quadrants x and y, respectively, where x and y represent any two of the available quadrants. Similarly, bits 2-3 of each phit are mapped to bit 1 of quadrants x and y, and so forth.

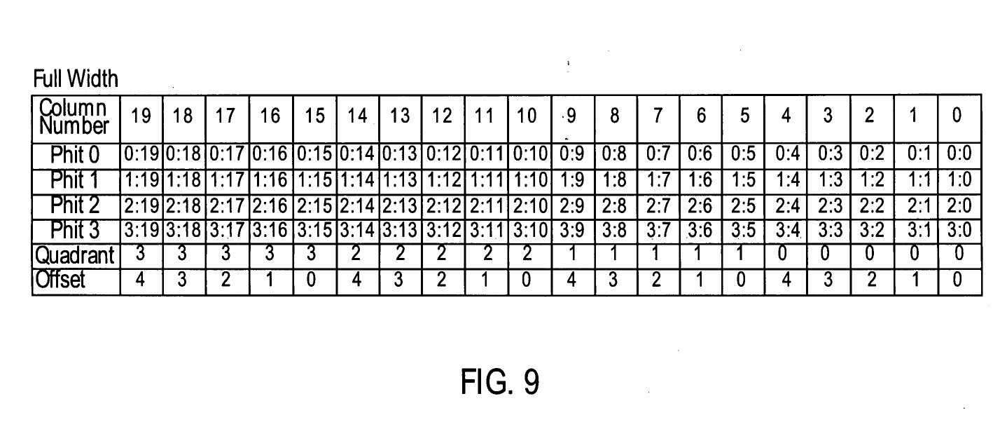

FIG. 8 illustrates the flit format and phit order for a quarter-width link, according to one embodiment of the invention, wherein one 80 bit flit is organized in sixteen 5 bit phits. Each bit is assigned a quadrant number 801 and an offset number 803, in one embodiment of the invention. The quadrant number represents a quarter section of a link, whereas the offset number represents the bit position within the quadrant.

In one embodiment, the phits are transmitted across the link according to the quadrant/offset map 805 in FIG. 8. However, unlike the full-width or half-width link, the quarter-width link has a physical width of 5 lanes. Therefore, only one quadrant (x) is used to transmit each phit, where x represents any of the available quadrants. For example, for each phit transmitted across the 5 lane physical link, bit 0 of a phit is assigned to bit position 0 of quadrant x. Similarly, bit 1 of each phit is mapped to bit 1 of quadrant x, and so forth.

If certain lanes are designated as static lanes with certain static values, not all bits of each phit are transmitted across the physical link. In one embodiment of the invention, up to four lanes of 20 lanes (in the case of a 20 lane link) are designated to be static, or “virtualized”. Furthermore, in at least one embodiment of the invention, only the lanes used to transmit CRC and sideband information across the physical link are virtualized. However, in other embodiments of the invention, the number of lanes in a physical link may be more or less than 20, the number of virtualized lanes may be more or less than 4, and the lanes that may be virtualized may include more, less, or different lanes than those used to transmit CRC and sideband information.

Designation of the width of the physical link between two devices or electronic elements during the configuration state of FIG. 4, also effects the designation of the virtualized lanes. For example, in FIG. 6, the columns 607 indicate that bits 0, 1, 18, and 19 of phits 0-3 are designated as being eligible for virtualization, in one embodiment of the invention in which the physical link is configured as a full-width link. Fewer than the four lanes may actually be virtualized in a given application, however.

Similarly, in FIG. 7, columns 707 indicate that bits 0 and 9 of phits 0-7 are designated as being eligible for virtualization, in one embodiment of the invention in which the physical link is configured as a half-width link. Although for 20 lanes (organized as two 10-bit phits) there are still four lanes that may be virtualized, fewer than four lanes may actually be virtualized in a given application.

Somewhat dissimilarly, in FIG. 8, regions 807 indicate that bit 0 of phits 0, 1, 4, 5, 8, 9, 12, and 13 and bit 4 of the remaining phits are designated as being eligible for virtualization, in one embodiment of the invention in which the physical link is configured as a quarter-width link. Because the virtualized lanes are dependent upon the phit being transmitted across the quarter-width physical link, the respective I/O's of the virtualized lanes may not be able to be powered off and the pins corresponding to the virtualized pins may not be unpopulated throughout the operation of the link. However, at least some power savings may be realized by not transmitting dynamically changing data across the virtualized lanes on each phit transmission cycle. Furthermore, although for 20 lanes (organized as four 5-bit phits) there are still four lanes that may be virtualized in the organization illustrated in FIG. 8, fewer than four lanes may actually be virtualized in a given application. Further power may be saved in some embodiments wherein the columns to be virtualized are done so in a way that ensures column 1 is always virtual, for example.

In each of the link width configurations illustrated in FIGS. 6-8, a number of quadrants are designated for the transmission of dynamically changing data across the physical link in order to transmit a 20 bit groups (“chunks”) of data. In other embodiments, the chunk size may be smaller or larger than 20 bits, depending upon the link width and the number of lanes designated as being eligible to transmit data.

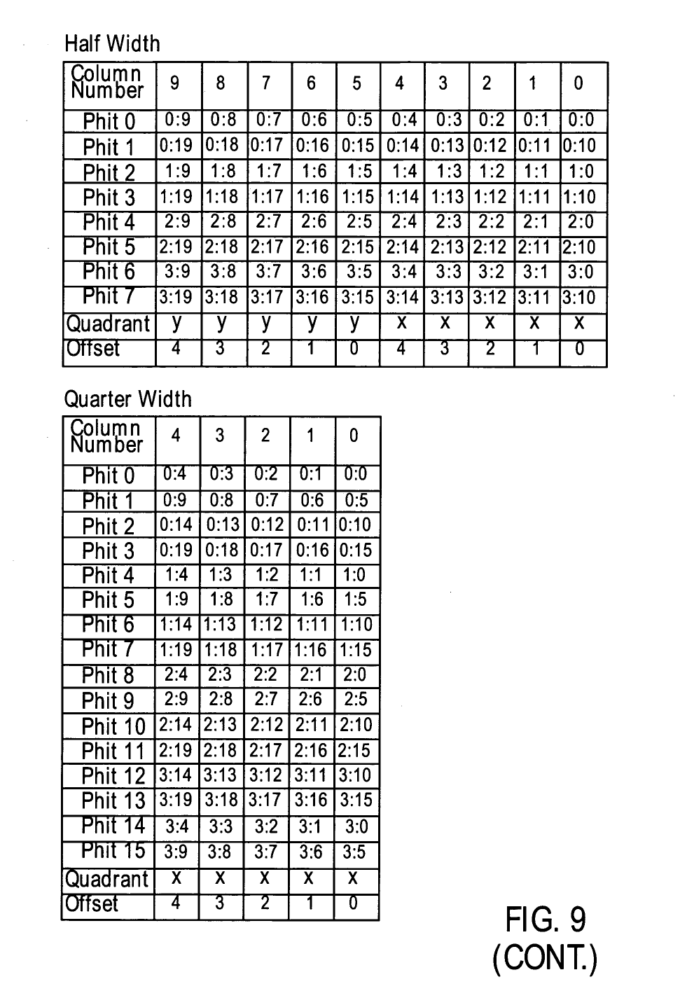

FIG. 9 illustrates a flit format and phit ordering for a full, half, and quarter-width link system, according to one embodiment, having different bit groupings than those of FIGS. 6-8. Referring to the flit format/phit ordering map for a full-width (20 lanes) link system, for each phit transmitted across the 20 lane physical link, bits 0 through 4 of a phit are assigned to bit position 0 of quadrants 0 through 4, respectively. Similarly, bits 5-9 of each phit is mapped to bit 1 of quadrants 0 through 4, and so forth. In FIG. 9, bits of each quadrant are grouped and transmitted sequentially rather than being interleaved with each other, regardless of the width of link used.

Referring to the flit format/phit-ordering for the half-width link system of FIG. 9, each of the two quadrants are mapped side-by-side rather than being interleaved, as in FIG. 7. Not also that the phit-ordering is different than that of FIG. 7. Particularly, bits 0-19 of phit 0 are organized sequentially in the first two phits (from right to left) rather than comingling the phit bit positions, as in FIG. 7. Accordingly, the bit grouping illustrated in FIG. 9 enables the phits to be transmitted as two side-by-side quadrants of 5 bits each.

Referring to the flit format/phit-ordering map for a quarter-width link system in FIG. 9, the bits of each phit are organized sequentially within the same quadrant, similar to the half-width link system. Accordingly, the bit grouping FIG. 9 enables the phit bits to be transmitted across a quarter-width link as one quadrant of five bits in width as in FIG. 8.

Other bit groupings may be used in other embodiments of the invention. Accordingly, the particular grouping of bits to be transmitted across a link is not necessary for one of ordinary skill in the art to practice embodiments of the invention.

In one embodiment of the invention, the link may be reconfigured while still allowing data to be transmitted across the link by using a portion of the link (i.e., a number of lanes less than the total number of lanes in the link) to conduct the training sequence while can continue to be transmitted across the link of the lanes that aren't used to perform the training sequence. For example, in one embodiment the width of the link may be reconfigured while data continues to be transmitted across the link, whereas in other embodiments the lanes upon which the data is transmitted may be reconfigured while data continues to be transmitted across the link. In other embodiments, both the link width and the link's lanes may be reconfigured while data continues to be transmitted across the link.

In various embodiments of the invention, in which data transmitted across the links are organized along quadrants in a manner previously described, a link may be reconfigured by allowing a training sequencing to be performed within one or more lanes, while data can continue to be transmitted within the remaining lanes. For example, in one embodiment in which a link is organized along four quadrants, “Q0”, “Q1”, “Q2”, and “Q3”, any two of the quadrants may be used to perform a training sequence to reconfigure the link while the remaining two quadrants are used to transmit data across the link. Once the link is reconfigured, all quadrants in the reconfigured link may be used to transmit data. In other embodiments one quadrant or three of the four quadrants may be used to either transmit data or transmit the training sequence during link reconfiguration while the remaining quadrants are used for transmitting training sequence information or data, respectively.

In one embodiment, data may be transmitted on a first set of lanes while a training sequence is transmitted a second set of lanes to reconfigure the link to transmit data on the second set of lanes. The link may then use the second set of lanes to transmit data while a training sequence is transmitted across the first set to reconfigure the link. The process may continue, in one embodiment, by continually switching the use of the first and second set of lanes between transmitting a training sequence and transmitting data, respectively. In one embodiment, the first and second set of lanes each consist of two lanes, whereas in other embodiments each may consist of another number lanes, which may or may not be the same number of lanes.

In one embodiment, a training sequence may include operations described earlier in regard to the polling state. Specifically, in at least one embodiment, the training sequence used to reconfigure the lanes may consist only of operations to remove skew between the clock and data this being transmitted across the link. In other embodiments, the training sequence used to reconfigure the lanes may consist of only removing skew between the clock and the data as well as between the data themselves. Still, in other embodiments, other operations may also be performed in the training sequence to reconfigure the lanes, including any or all of those previously described in reference to FIG. 4.

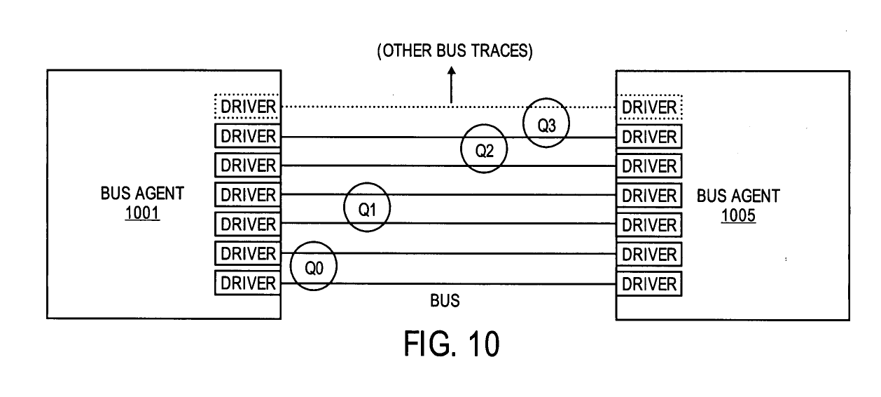

FIG. 10 illustrates a link in which quadrants Q0 and Q1 are used to transmit data across the link, while quadrants Q2 and Q3 are used to transmit the training sequence between agents 1001 and 1005. In the embodiment illustrated in FIG. 10, data will be transmitted on all lanes of the reconfigured link after the link has been “retrained” by the completion of the training sequence. Also, in FIG. 10, each quadrant of data may be transmitted across more than one lane.

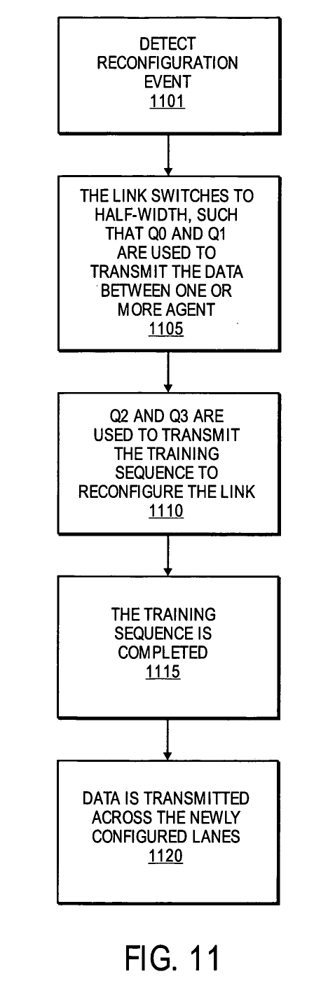

FIG. 11 is a flow diagram illustrating operations used in at least one embodiment of the invention. At operation 1101, a link reconfiguration event is detected. In one embodiment, the width of the link is reconfigured. In another embodiment, the lanes upon which data is to be transmitted is reconfigured. In yet another embodiment both the link width and lanes upon which data is to be transmitted is reconfigured. At operation 1105, the link switches to half-width, such that Q0 and Q1 are used to transmit the data between one or more agents, while at operation 1110, Q2 and Q3 are used to transmit the training sequence to reconfigure the link. At operation 1115, the training sequence is completed and at operation 1120 data is transmitted across the newly configured lanes.

Embodiments of the invention described herein may be implemented with circuits using complementary metal-oxide-semiconductor devices, or “hardware”, or using a set of instructions stored in a medium that when executed by a machine, such as a processor, perform operations associated with embodiments of the invention, or “software”. Alternatively, embodiments of the invention may be implemented using a combination of hardware and software.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

What is claimed is:

1. An electronics system comprising:
a first bus agent to receive information from a second bus agent across a link comprising lanes, the link to transmit data cross a first plurality of lanes while a second plurality lanes of the link are used to transmit a training sequence.

2. The electronics system of claim 1 wherein the training sequence is to cause the link to be reconfigured.

3. The electronics system of claim 1 wherein the training sequence is to reconfigure the width of the link among one of a plurality of possible interconnect width modes.

4. The electronics system of claim 1 wherein the training sequence is to reconfigure the number of lanes of the link.

5. The electronics system of claim 3 wherein the one of the plurality of possible interconnect width modes is chosen from a group consisting of: quarter-width, half-width, and full-width.

6. The electronics system of claim 1 wherein the training sequence is to be transmitted across a first half of the lanes and the data is to be transmitted across a second half of the lanes of the link.

7. The electronics system of claim 6 wherein the first half of lanes comprises two quadrants and the second half of lanes comprises two quadrants.

8. The electronics system of claim 7 wherein the first and second bus agents are semiconductor devices within a point-to-point network of semiconductor devices of a computer system.

9. A computer system comprising:
a memory unit to store at least one instruction, which if executed by a processor, would cause a link to be reconfigured, wherein only a first portion of the link is to transmit a training sequence while only a second portion of the link is to transmit data between at least two interconnect agents.

10. The computer system of claim 9 wherein the first portion has a width equal to the second portion.

11. The computer system of claim 10 wherein the first and second portions comprise two quadrants.

12. The computer system of claim 9 wherein the first portion has a width that is smaller than the second portion.

13. The computer system of claim 12 wherein the first portion comprises one quadrant and the second portion comprises three quadrants.

14. The computer system of claim 9 wherein the first portion has a width that is larger than the second portion.

15. The computer system of claim 14 wherein the first portion comprises three quadrants and the second portion comprises one quadrant.

16. The computer system of claim 9 wherein the link comprises a plurality of lanes.

17. A system comprising:
a first agent to communicate data to a second agent;
an interconnect across which the data is to be communicated from the first agent to the second agent concurrently with a training sequence to configure the interconnect.

18. The system of claim 17 wherein the data is to be transmitted on a separate set of lanes from the training sequence.

19. The system of claim 18 wherein only a subset of lanes are to be coupled to the first and second agent.

20. The system of claim 17 wherein the width of the interconnect is to be configured by the training sequence.

21. The system of claim 18 wherein the number of lanes of the interconnect is to be configured by the training sequence.

22. The system of claim 18 wherein the width and the number of lanes of the interconnect is to be configured by the training sequence.

23. The system of claim 18 wherein the first and second bus agents comprise at least as many input/output (I/O) circuits as lanes within the interconnect.

24. The system of claim 23 wherein each of the I/O circuits are to be disabled if the lane to which they correspond is not used to transmit information.

25. The system of claim 24 wherein the first and second agents and the interconnect are part of a point-to-point network of electronic devices.

26. A method comprising:
detecting a network link reconfiguration event;
transmitting a training sequence on a first portion of the link to reconfigure the link; transmitting data on a second portion of the link from a first agent to a second agent concurrently with the training sequence being transmitted on the first portion of the link;
reconfiguring the width of the link.

27. The method of claim 26 wherein a number lanes within the link are determined by either or both of the two agents communicating the training sequence.

28. The method of claim 27 wherein the static lanes are indicated in a sixth field of the sequence and the value of the static lanes are indicated in the seventh field of the sequence.

29. The method of claim 28 wherein the link couples two common system interface (CSI) agents.

30. The method of claim 26 wherein half of the link is to be used to transmit the training sequence and the other half of the link is to be used to transmit the data.
